(19) United States
(12) Patent Application Publication
(10) Pub. No.: US 2011/0113974 A1
(43) Pub. Date: May 19, 2011

(54) GRILL RACK SYSTEM

(76) Inventors: JAMES D'AMATO, Glen Rock, NJ (US); John Battaglia, Westwood, NJ (US)

(21) Appl. No.: 12/619,844

(22) Filed: Nov. 17, 2009

(51) Int. Cl. A47J 43/18; B23P 17/04

(52) U.S. Cl. 99/426; 29/428

(57) ABSTRACT

A grilling or cooking system is provided providing ready transport, rapid assembly, and secure use. A substantially rigid mounting member contains a plurality of stiffening elongate planar sections at off-set angles relative to one another. Outer opposed edges of outer opposed planar sections of the mounting member contain a respective plurality of mounting regions are shaped for receiving and removably portions of food to be grilled. The off-set angles aid for retention of the food members while serving to stiffen the system. The mounting regions are preferably a plurality of off-set slot members. The proposed cross-section structure allows for distribution of grilling fluid while securely regaining slippery food products during use. Removable and replaceable spring leg members engage opposing support holes on positions of planar sections on distal and proximate ends of the rigid mounting member, while also allowing easy cleaning, part replacement, and support of the food members at a fixed distance from a heat source.

### CROSS REFERENCE TO RELATED APPLICATIONS

This application relates to and claims priority from U.S. Ser. No. 11/307,329 filed Feb. 1, 2006, currently pending, the entire contents of which are herein incorporated fully by reference.

### BACKGROUND OF THE INVENTION

1. Field of the Invention

The present invention relates to a grill or cooking rack system and facilitates particularly to a rack for cooking elongate food members like chicken legs in a new and improved manner with an inexpensive and efficient device. More specifically, the present invention relates to a grilling rack to securely retain grilling elongate food products like chicken legs, chicken wings, ribs, strips or other portions which are coated in a substance on an external surface making them slippery to secure during grilling, yet allowing swift removal following use, and storage in a compact shape.

2. Description of the Related Art

In barbecuing chicken legs, it is extremely difficult to cook the legs uniformly without burning. The legs must consistently be watched and rotated on the grill. Unfortunately, even with considerable attention, it is quite easy to burn the legs or cook the legs in a non-uniform manner.

In the related arts, U.S. Pat. No. 2,269,310, discloses a display device for supporting and displaying axe and shovel handles. The device includes a plurality of spaced parallel slots with openings at one end. The device is intended for a use different from the present invention and apart from apparent similarity of parallel slots is different in structure.

U.S. Pat. No. 4,554,869 is directed to an adjustable barbecue rack for supporting a plurality of spareribs. The device includes a plurality of racks removably secured to a main rack. Another version of a barbeque rack is shown in U.S. Pat. No. 4, 458,585 wherein a cooking surface is defined by spaced rods formed in a particular manner.

U.S. Pat. No. 5,730,046 discloses a flat platform with downwardly extending side portions having tubular legs to support the rack at a predetermined distance above the fire.

Other patents of general interest included U.S. Pat. Nos. 4,677,906; 4,583,647; 4,765,584; 4,184,592; and 4,542,684. None of the prior art patents mentioned above provide the inventive solution proposed by the present system.

What is not appreciated by the prior art is the need for an improved grilling system.

Accordingly, there is a need for an improved grilling system, and the present invention is designed to permit uniform cooking of a plurality of chicken legs, wings, strips, or ribs, without the problems associated with the prior art methods. The invention comprises a unique rack system which is readily compacted yet can bear substantial food weight and is readily stored and cleaned. The proposed grill rack system secures legs in a vertical position spaced at a predetermined distance above a heat source for uniform cooking without the problem of burning.

### ASPECTS AND SUMMARY OF THE INVENTION

An aspect of the present invention is to provide an innovative grill rack system.

Another object of the present invention is to provide a system wherein uniform cooking of a plurality of chicken legs, wings, strips, or ribs, is optimized without the problems associated with the prior art methods.

According to one aspect of the present invention, the grill system discloses a unique transportable rack system which is readily compacted yet can bear substantial food weight more than ten-times the weight of the grill itself, and is readily stored and cleaned following use.

According to another aspect of the proposed grill rack system removable legs are secured by spring force in a vertical position spaced at a predetermined distance above a heat source for uniform cooking without the problem of burning.

The invention relates to cooking devices and particularly to a device or rack for grilling chicken legs on a barbecue. The prior art devices for grilling chicken legs were generally no more than an open grill where the legs had to be constantly rotated to prevent burning. In the present invention, the legs are suspended from a specially designed rack at a predetermined distance above the fire to permit uniform cooking without burning.

The unique rack of the present invention comprises a flat metal structure with cutouts and with collapsible or optionally removable legs, which maintain a structure a predetermined distance above the grill. The structure, which is generally rectangular, includes a plurality of cutout regions, circles and slots about the periphery to accommodate food items. In one optional embodiment, the flat structure may also include a center aperture for insertions of legs and a connecting slot to hold a plurality of legs in the slot. The race may also include a handle and may include several apertures with connecting slots depending on the size of the rack.

In one exemplary embodiment, the legs comprise a wire base and upwardly extending wire members at each end of the base, which pivotably mount to downwardly extending flanges on the corners of the flat metal structure. The rack may be coated with a non-stick coating.

A further optional aspect of this invention is to provide a new and improved grill or barbeque rack wherein a plurality of food members, preferably chicken legs and wings may be release-ably mounted in a hanging position with the meaty portions extending downwardly from a plurality of slots to permit uniform grilling and prevent burning.

A further optional aspect of this invention is to provide an inexpensive flat metal surface having a plurality of alternating slots and circles about its periphery for holding chicken legs and wings respectively, and an enlarged hole in the surface thereof, permitting legs to be inserted through the hole and held in place along the slot with pivotal legs maintaining the flat surface a predetermined distance above the grill.

In yet a further optional aspect of the present invention the structure of the grill rack is bent at least one time relative to a reference plane, and preferably twice, so that the bent brakes provide strengthening and rigidity to the sheet material, allowing use of a thinner gauge material.

In another optional aspect of the present invention, a plurality of edge-positioned cut out slots is provided that enable optional inter-use of differing grill support members with the same leg support members.

The present invention relates to a grilling system is provided providing ready transport, rapid assembly, and secure use. A substantially rigid mounting member contains a plurality of elongate planar sections at off-set angles. Outer opposed edges of outer opposed planar sections of the mounting member contain a respective plurality of mounting regions for receiving portions of food to be grilled. The of-set angles aid for retention of the food members. The mounting regions are preferably a plurality of off set slot members. The cross-section structure allows for distribution of grilling fluid while securely regaining slippery food products during use. Removable and replaceable spring leg members engage opposing support holes on positions of planar sections on distal and proximate ends of the rigid mounting member, while also allowing easy cleaning, part replacement, and support of the food members at a fixed distance from a heat source.

According to an embodiment of the present invention there is provided a grill rack, comprising: a rigid mounting member comprising at least two or three or four or more elongate planar sections, each the elongate planar section being jointed to at least one adjacent elongate planar section along an alternating off-set angle region whereby each the elongate planar section is non-coplanar with respect to an adjacent the elongate planar section and whereby each the elongate planar section is nonparallel with an external support surface, outer ones of the elongate planar sections containing a plurality of off-set slot contours, each the outer one of the elongate planar sections being non-coplanar with the opposing outer one of the elongate planar sections, each the off-set slot contour extending from an external edge of the rigid mounting member to proximate the off-set angle region.

According to an alternative embodiment of the present invention there is provided a grill rack, further comprising: a pair of continuous spring leg members, each the leg member being a continuous bent member, wherein opposing end regions project upwardly away from the external support surface along a perpendicular reference plane, projecting entry members on respective ends of each the end region, each the entry member projecting opposite the entry Member projecting from the opposing end region, whereby the entry members project away from each other, and at least one mounting member for each the projecting entry member, each the mounting member being mounted on respective the alternating off-set angle regions.

According to an alternative embodiment of the present invention there is provided a grill rack, wherein: pairs of the mounting members proximate opposing ends of the rigid mounting member, and one of each the pair of the mounting member being spaced from the respective end of the rigid mounting member a distance different than a respective spaced distance for the other one of each the pair, whereby each one of each the pair of mounting member is a different distance from the respective end of the rigid mount member, and whereby during an assembly of the continuous spring leg members with respective the mounting members an urging spring force is created by urging respective end regions a direction away from the perpendicular reference plane to engage the mounting members thereby achieving an engagement while maintaining a first direction spring tension in each the leg member.

According to an alternative embodiment of the present invention there is provided a grill rack, wherein: opposing end regions of each respective spring leg member projecting upwardly in a co-parallel manner away from the external support surface, and the co-parallel manner is a first separation distance, each respective the mounting members on respective the ends being mounted distant from the each other at a distance that is greater than the first separation distance of opposing end regions of each the spring leg member, and whereby during the engagement the end regions are urged away from each other to achieve the engagement thereby maintaining a second direction spring tension in each the leg member.

According to an embodiment of the present invention there is provided a method of assembling a grill system, comprising the steps of: providing a rigid mounting member comprising an even number of elongate planar sections, wherein: each the elongate planar section being jointed to at least one adjacent elongate planar section along an alternating off-set angle region whereby each the elongate planar section is non-coplanar with respect to an adjacent the elongate planar section and whereby each the elongate planar section is nonparallel with an external support surface, outer ones of the elongate planar sections containing a plurality of off-set slot contours, each the outer one of the elongate planar sections being non-coplanar with the opposing outer one of the elongate planar sections, and each the off-set slot contour extending from an external edge of the rigid mounting member to proximate the off-set angle region.

According to an embodiment of the present invention there is provided a method of assembling a grill system, further comprising the steps of: providing a pair of continuous spring leg members, each the leg member being a continuous bent member, wherein opposing end regions project upwardly away from the external support surface along a perpendicular reference plane, projecting entry members on respective ends of each the end region, each the entry member projecting opposite the entry member projecting from the opposing end region, whereby the entry members project away from each other, providing at least one mounting member for each the projecting entry member, and each the mounting member being mounted on respective the alternating off-set angle regions.

According to an embodiment of the present invention there is provided a method of assembling a grill system, further comprising the steps of: providing pairs of the mounting members proximate opposing ends of the rigid mounting member, one of each the pair of the mounting member being spaced from the respective end of the rigid mounting member a distance different than a respective spaced distance for the other one of each the pair, whereby each one of each the pair of mounting member is a different distance from the respective end of the rigid mount member, and whereby during an assembly of the continuous spring leg members with respective the mounting members an urging spring force is created by urging respective end regions a direction away from the perpendicular reference plane to engage the mounting members thereby achieving an engagement while maintaining a first direction spring tension in each the leg member.

According to an embodiment of the present invention there is provided a method of assembling a grill system, further comprising the steps of: controlling the opposing end regions of each respective spring leg member projecting upwardly in a co-parallel manner away from the external support surface, and the co-parallel manner is a first separation distance, whereby each respective the mounting members on respective the ends being mounted distant from the each other at a distance that is greater than the first separation distance of opposing end regions of each the spring leg member, and whereby during the engagement the end regions are urged away from each other to achieve the engagement thereby maintaining a second direction spring tension in each the leg member.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective view of one embodiment of a rack system with the rack legs in an open position for placement on a barbecue support surface, a close-up view is provided.

FIG. 2 is a perspective view of the embodiment of the rack system shown in FIG. 1 with the rack legs in a closed position for storage purposes.

FIG. 3 is a top view of an alternate embodiment of the grill holding system noted in FIGS. 1 and 2, wherein an optional inner cut-out is shown.

FIG. 4 is a perspective view of an alternative embodiment of the present invention.

FIG. 4A is a perspective view of the embodiment in FIG. 4 in a use condition.

FIG. 5 is an exploded view of the embodiment in FIG. 4 noting the leg spring effect.

FIG. 6 is a partial view of the operation of leg mounting.

FIG. 7 is an alternative top plan view noting alternative mounting contour.

FIG. 8 is a side elevation view of FIG. 7.

FIG. 9 is an end view of FIG. 7, noting the position of receiving openings on the rigid mounting members.

FIGS. 10, 11, 12, and 13, provide an alternative rigid mounting member.

FIGS. 14, 15, 16, and 17, provide an alternative rigid mounting member.

FIGS. 18, 19, 20, and 21, provide an alternative rigid mounting member.

FIGS. 22, 23, 24, and 25, provide an alternative rigid mounting member.

FIGS. 26, 27, 28, and 29, provide an alternative rigid mounting member.

FIGS. 30, 31, 32, and 33, provide an alternative rigid mounting member.

FIGS. 34, 35, 36, and 37, provide an alternative rigid mounting member.

FIGS. 38, 39, 40, and 41, provide an alternative rigid mounting member.

FIGS. 42, 43, 44, and 45, provide an alternative rigid mounting member.

FIGS. 46, 47, 48, and 49, provide an alternative rigid mounting member.

FIGS. 50, 51, 52, and 53, provide an alternative rigid mounting member.

FIGS. 54, 55, 56, and 57, provide an alternative rigid mounting member.

FIGS. 58, 59, 60, and 61, provide an alternative rigid mounting member.

FIGS. 62, 63, 64, and 65, provide an alternative rigid mounting member.

FIGS. 66, 67, 68, and 69, provide an alternative rigid mounting member.

FIGS. 70, 71, 72, and 73, provide an alternative rigid mounting member.

FIGS. 74, 75, 76, and 77, provide an alternative rigid mounting member.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

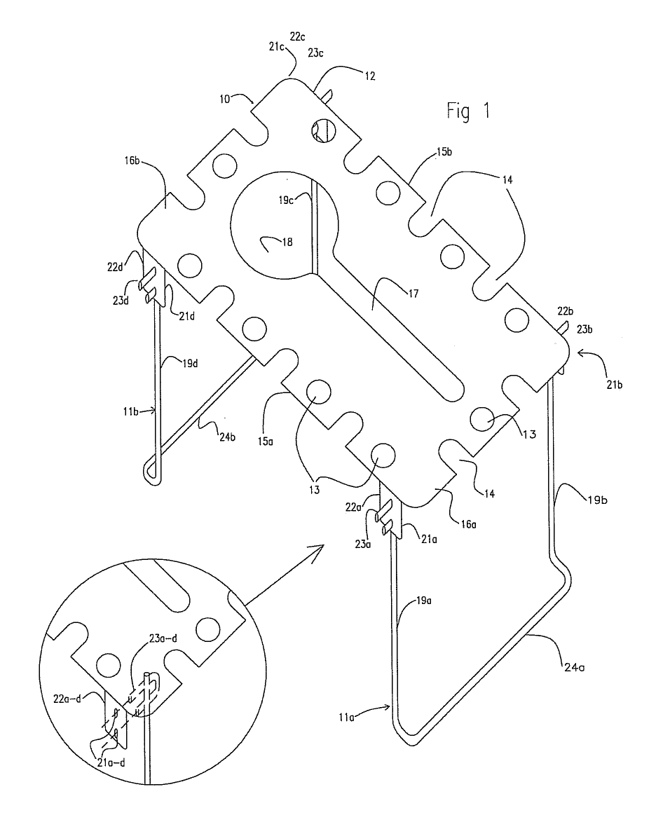

Referring now to FIG. 1 of the drawings, the invention comprises a grill rack 10 primarily for chicken legs and wings. The rack 10 is designed to rest on the grilling surface of a barbecue. The downwardly extending legs 11a and 11b position the flat surface 12 of the rack 10 at a predetermined distance above the grilling surface. Optionally, the flat surface 12 may be placed on the grill with the legs projecting upwardly so that skewers may be mounted between the legs 11a and 11b. The chicken legs and wings are positioned on to the flat surface 12 and extend downwardly so the legs and wings are uniformly cooked.

The flat surface or member 12 comprises a substantially rectangular metal member having a plurality of apertures 13 and slots 14 arranged along the periphery thereof. The illustration in FIG. 1 shows four apertures 13 and three slots 14 alternately arranged along the longer sides 15a and 15b of member 12 and two slots 14 and one central hole along the shorter sides 16a and 16b. The apertures 13 and slots 14 are arranged opposite a similar hole 13 or slot 14 on the other side of member 12. Having both slots 14 and apertures 13 adds to the versatility of the rack 10.

The circular apertures 13 are approximately 0.594 in diameter from one side to the other side. The apertures or holes 13 are designed to hold the irregular shape of wings while the slots 14 engage the lower bone in the chicken leg. Other shapes may be employed and the apertures 13 and the flat surface 12 could include all apertures 13 or all slots 14.

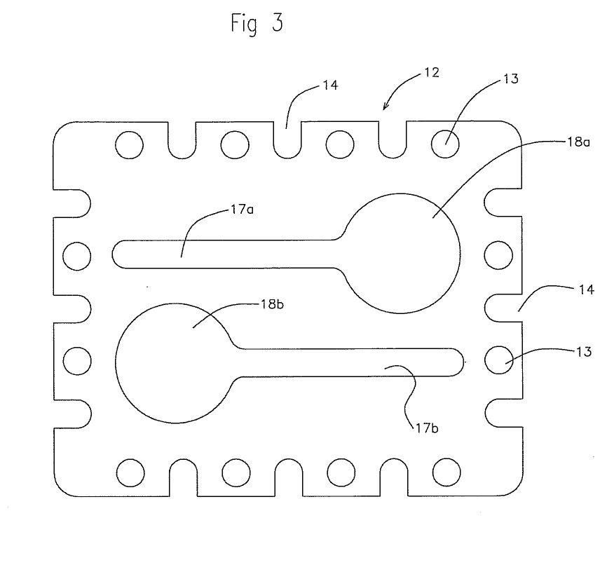

Extending longitudinally along the member 12 is a central slot 17 extending from an enlarged aperture 18. Chicken legs are inserted downwardly through the slot 17 and then fed along the slot 17 with the meaty side down to promote even cooking. Thus, a number of legs can be cooked in this slot 17. While one central slot aperture 18 is shown in FIG. 1, it is possible in larger racks to have more than one slot 17—aperture 18 as shown in FIG. 3 with slots 17a, 17b and apertures 18a, 18b.

The rack 10 includes pivotal leg members 11a and 11b at each end of the rack 10. Each leg member 11a, 11b includes upwardly extending elongated member 19a-d, which mount at one end to apertures 21a-d respectively in flanges 22a-d extending downwardly from member 12. The elongated member 19a-19d each includes upper perpendicular portions 23a-23d, which engages the apertures 21a-d. The legs 11a and 11b each include an offset transverse member 24a and 24b joining the respective elongated members 19a, 19b and 10c, 19d. In further embodiments, a t-slot or other connecting means may be used to join the legs 11a, 11b to the flat surface 12.

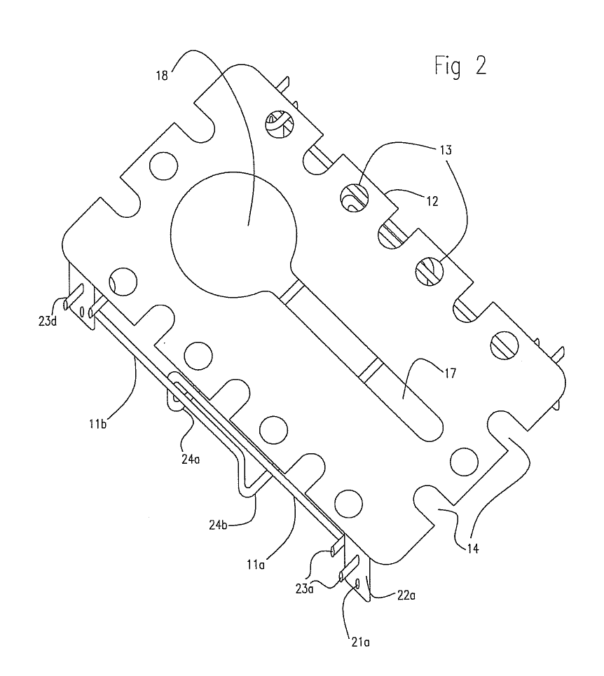

FIG. 2 depicts the rack in a folded position for storage or shipment with the pivoting wire legs 11a and 11b folded against one another. The legs 11a, 11b pivot about the flanges aperture 21a-21d when pressure is applied.

While the flat member 12 has been shown in a rectangular shape, other geometrical shapes can be used. The rectangular shape, however, is particularly suited for a typical barbecue. The substantially flat member 12 can be readily punched out and thus is inexpensive to produce. Furthermore, the member 12 can include a flange side portion to eliminate the individual flanges 22a-d and in some cases, the central slot/aperture can be eliminated to provide a flat cooking surface, which can have a non-stick coating. The legs 11a, 11b can also be fixedly mounted to the surface 12 and finally rack 10 itself can be mounted to the barbecue hood to be pivoted into position when the hood is opened.

Referring now to FIG. 3, an alternative flat member 12′ is provided with opposed slots 17a and 17b with respective apertures 18a, 18b. In this manner, one of skill in the art, having studied the enclosed discussion will appreciate that alternative constructions of openings and shapes of flat members 12, 12′ may be provided without departing from the scope and spirit of the present invention.

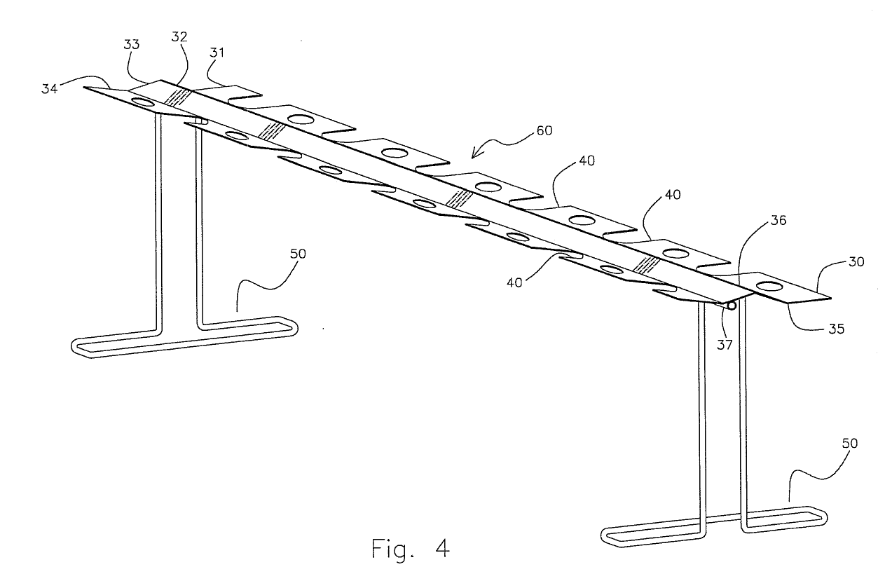

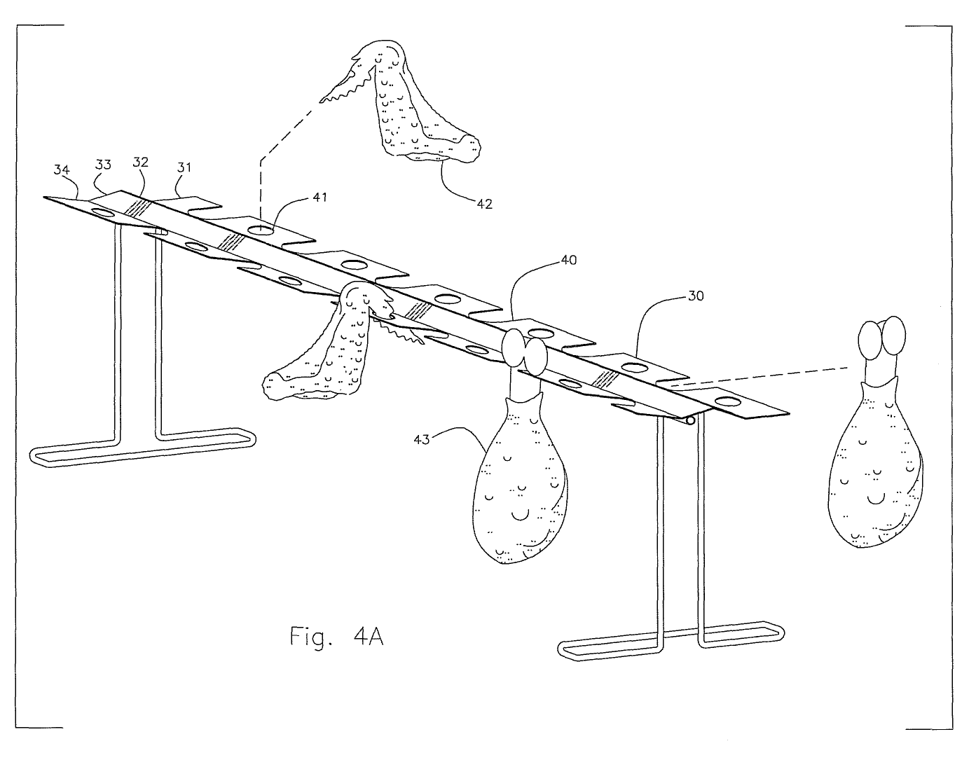

Referring now to FIGS. 4, 4A, 5, 6, 7, 8 and 9 a grill system 60 contains rigid mounting member 30 contains a plurality of elongate planar sections 31, 32, 33, and 34 joined along alternating off-set angle regions 35, 36, and 37, whereby said planar sections are not co-planar with each other. Opposing outer elongate planar sections 31 and 34 containing a plurality of off-set slot members 40. A series of holes 41 is also provided. As can be appreciated from FIG. 4A, food items as a wing 42 readily secure within holes 41, while chicken legs readily secure within slot members 40.

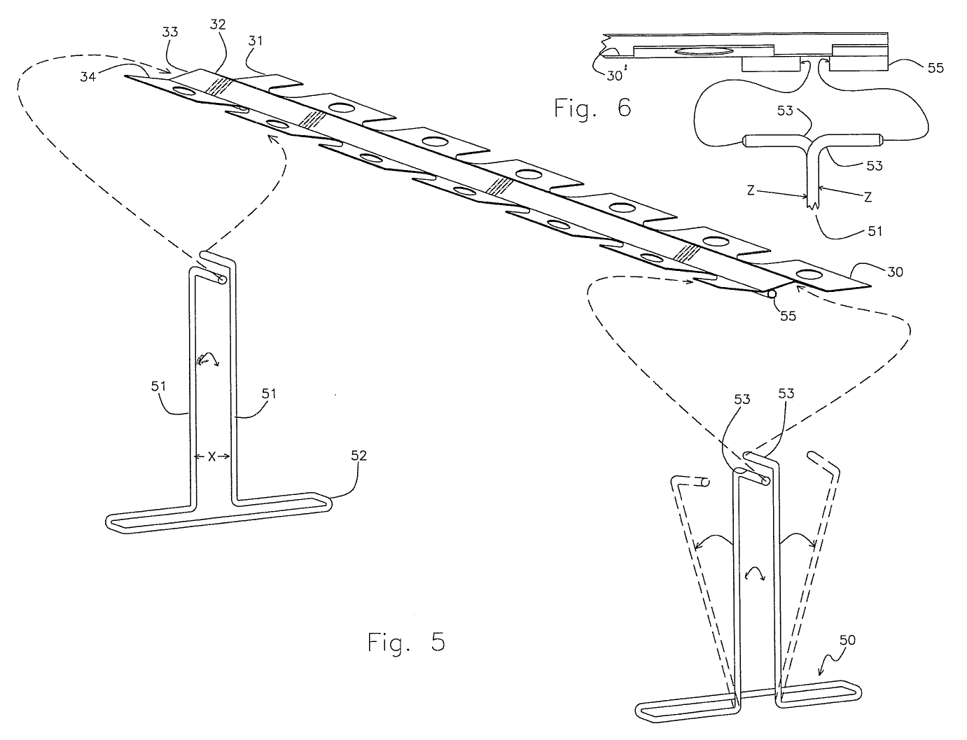

A pair of continuous spring wire leg members 50 each contain end leg members 51, 51 that project upwardly from a support member portion 52 along a common plane. Projecting end members 53 project away from each other as shown best in FIG. 5 and FIG. 6. Receiving openings 55 formed as tubes are secured proximate end portions of rigid mounting member 30.

As can be appreciated, the gauge or thickness of rigid mounting member 30 may be reduced by employing bent formation as noted with off-set angles on equal sides so that stiffness is secured while a very low weight is ensured. As will be further appreciated, noting herein restricts the shape of rigid mounting member 30 to the use of four elongate planar sections 31, 32, 33, and 34, indeed two planar sections may be employed and achieve related results.

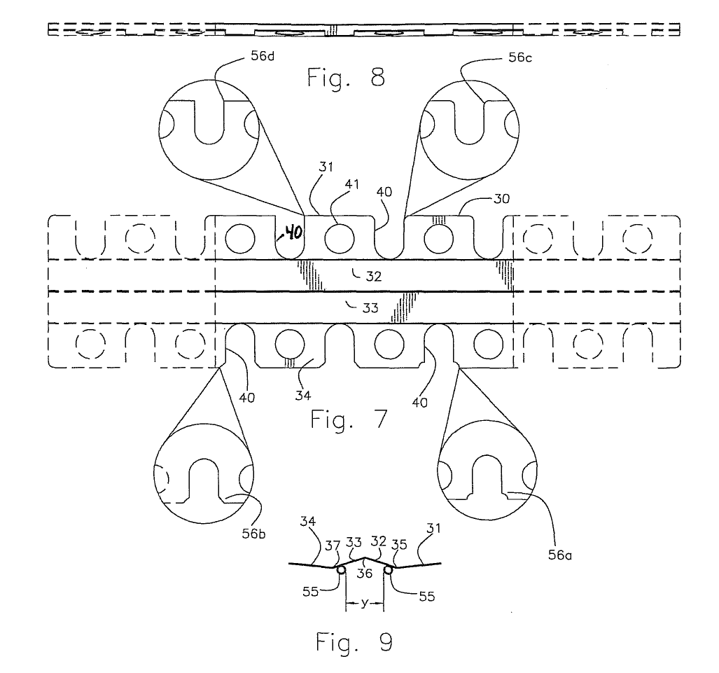

As will also be appreciated from studying FIG. 7, a variety of contours 56A, 56B, 56C, and 56D may be provided within the scope and spirit of the present invention.

Referring specifically now to FIGS. 5 and 6, leg members 51, in a non-use condition, extend parallel to each other a distance X. As can be seen in FIG. 9, receiving openings 55, 55 are at a distance Y, with Y being greater than or equal to distance X, such that an urging spring force exists in legs 51, 51 following insertion in receiving openings 55, 55, along a direction parallel with the plane of the legs. This spring force is created by the use of joined leg members.

Additionally, to insert leg members 51, 51 and end members 53, 53 into openings 55, 55, leg members must be bent from their neutral position along opposing directions Z, Z (FIG. 6) aligned with openings 55, 55. In urging legs 51, 51 along opposing directions Z, Z, the tip ends of end members 53, 53 are aligned with the front opening of openings 55, 55 and can slide inwardly therein. As a result of the current arrangement, the use of opposing directions Z, Z creates a second spring force to further urge and secure end members 53, 53 in hold members 55, 55.

As a result of the current construction, those of skill in the art having reviewed the current discussion, will readily appreciate that the use of off-set spring forces act to provide additional rigidity to leg members 50, 50 following installation and also to secure the connection assembly itself by the use of maintaining a spring tension in two vector directions (X-direction, and Z-direction).

Therefore one of the advantageous benefits of the present invention is realized, secure assembly in a manner which can readily support many times (up to or more than 10 times the weight of food relative to the weight of material in construction. As an additional benefit, the current knock-down assembly allows for simple packaging, replacement, cleaning, and storing of grill system 60.

Alternative embodiments of rigid mounting member 30 are proposed in the following figures without departing from the scope and spirit of the present invention.

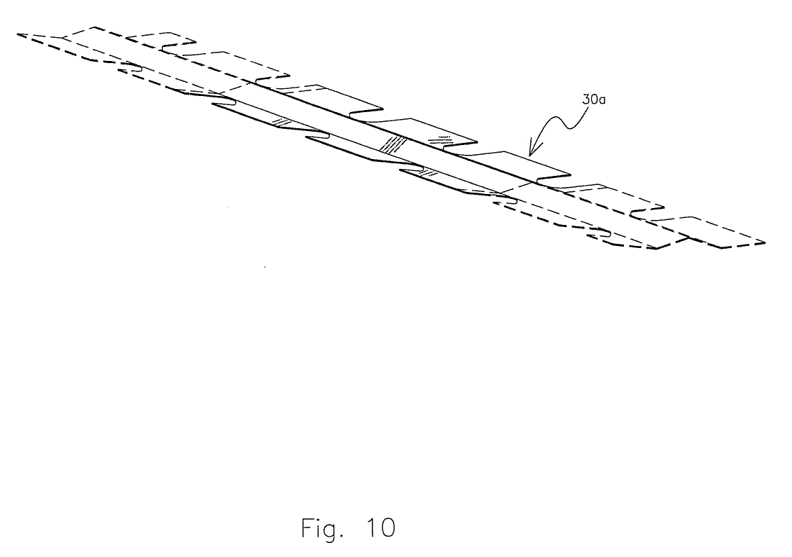

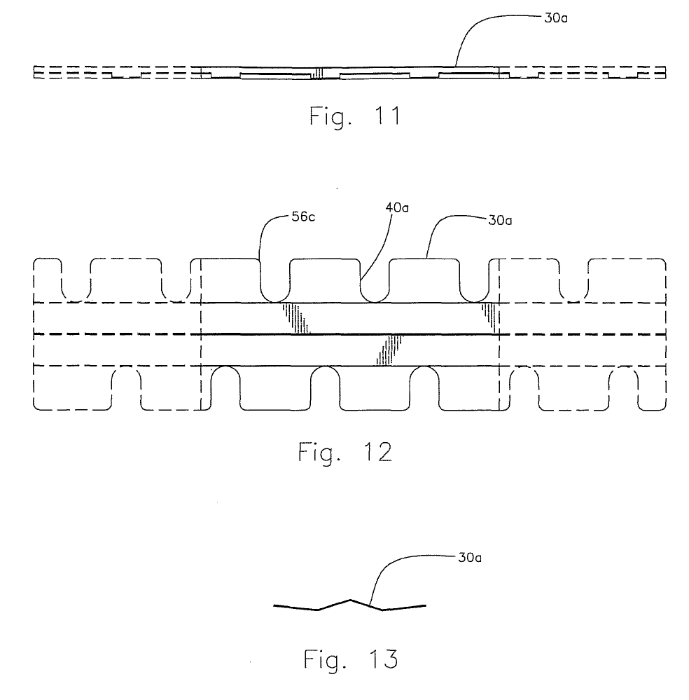

Referring now to FIGS. 10, 11, 12, and 13, an alternative rigid mounting member 30A is provided, containing arcuate slot members 40A containing a rounded radius corner 56C (as in FIG. 7).

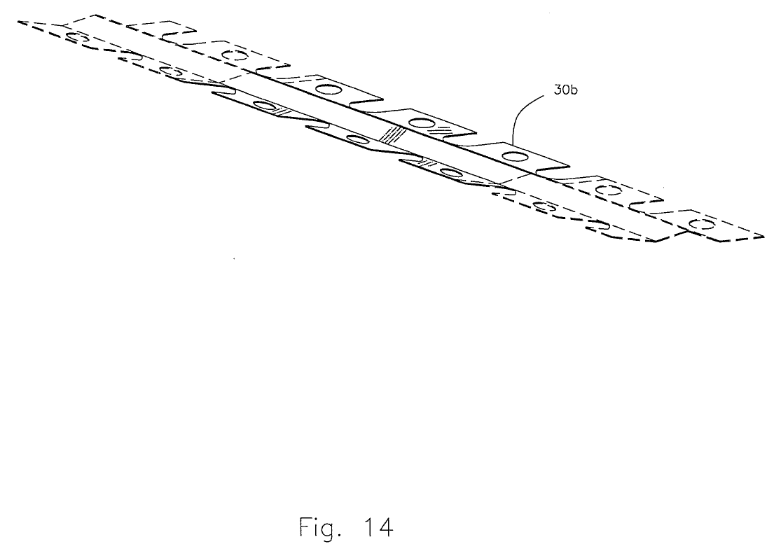

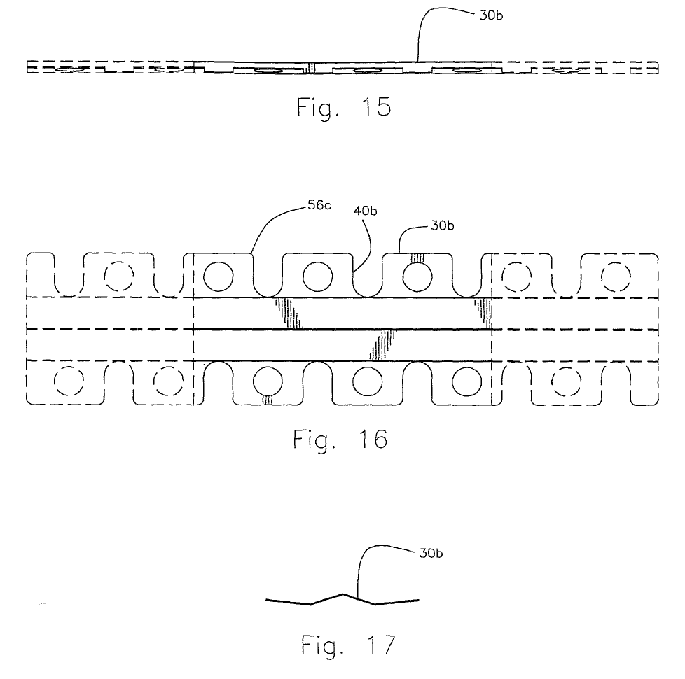

Referring now to FIGS. 14, 15, 16, and 17, an alternative rigid mounting member 30B is provided, containing arcuate slot members 40B containing a rounded radius corner 56C (as in FIG. 7).

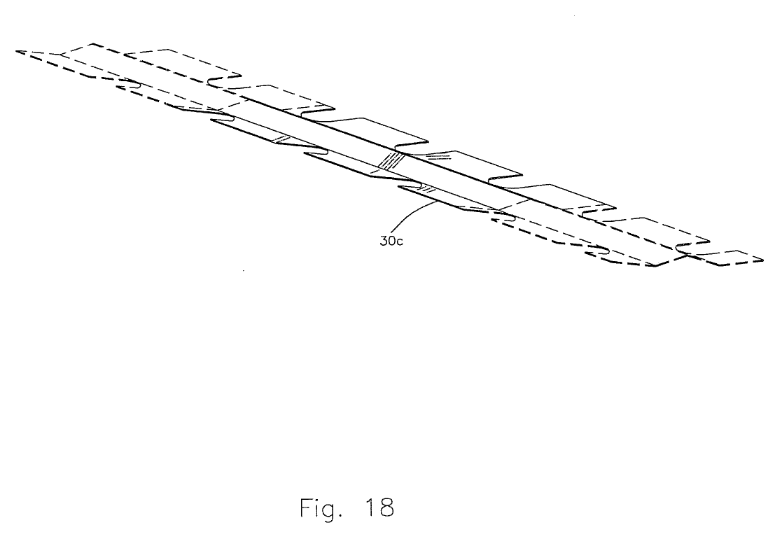

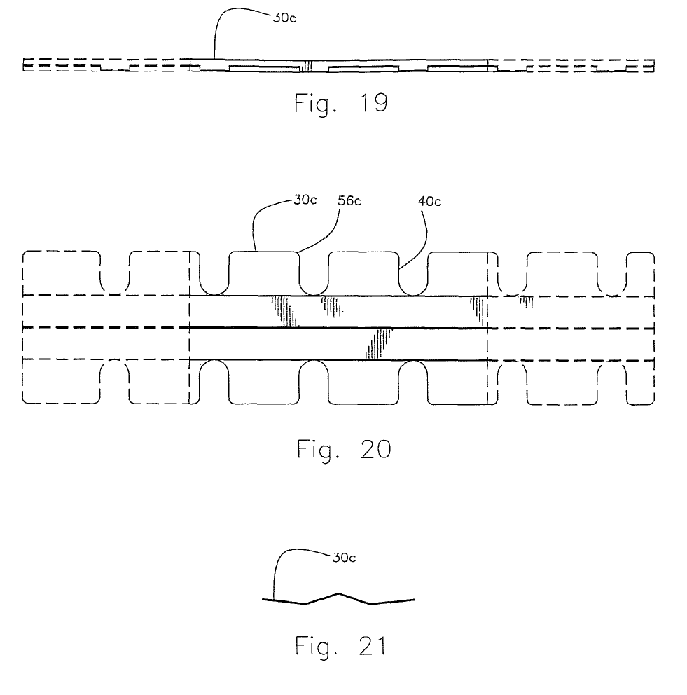

Referring now to FIGS. 18, 19, 20, and 21, an alternative rigid mounting member 30C is provided, containing arcuate slot members 40C containing a rounded radius corner 56C (as in FIG. 7).

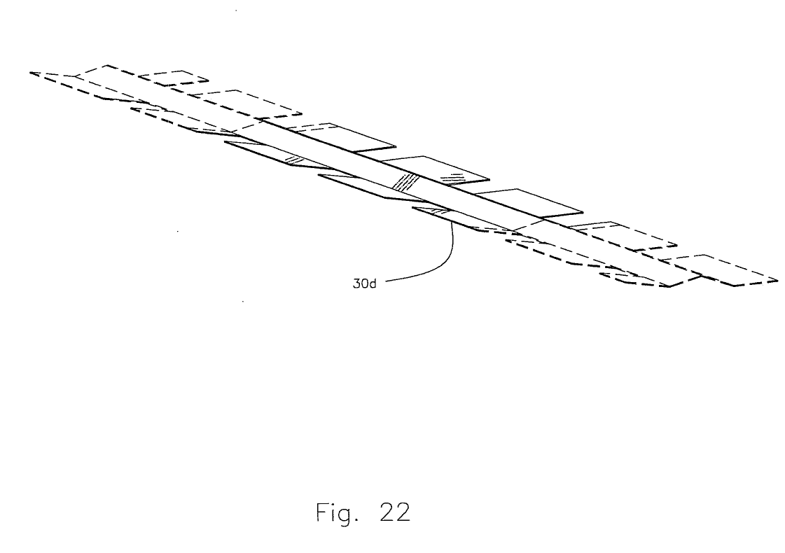

Referring now to FIGS. 22, 23, 24, and 25, an alternative rigid mounting member 30D is provided, containing arcuate slot members 40D containing a rounded radius corner 56C (as in FIG. 7).

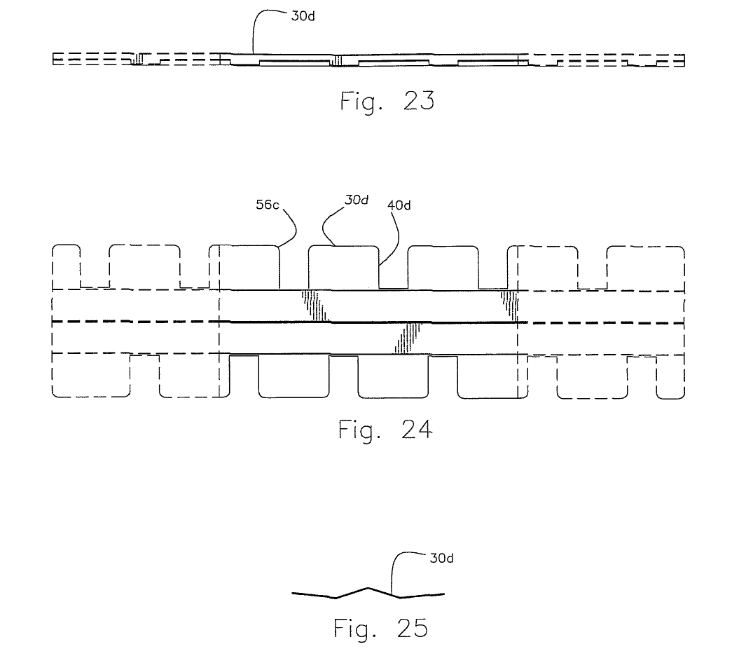

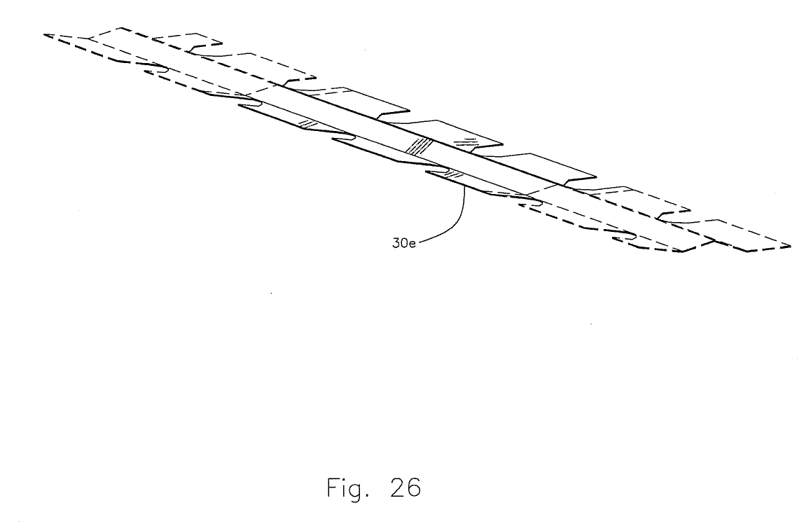

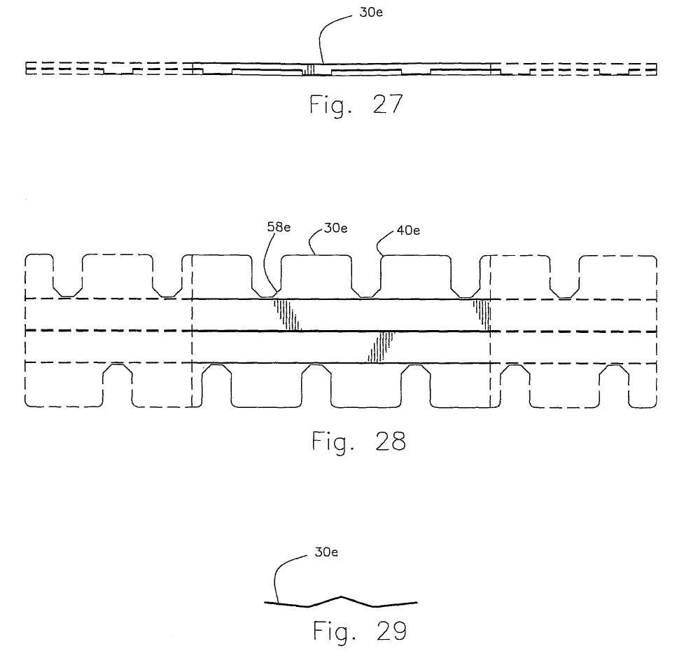

Referring now to FIGS. 26, 27, 28, and 29, an alternative rigid mounting member 30E is provided, containing arcuate slot members 40E containing an angled corner 56B (as in FIG. 7), and an angled inner profile 58E.

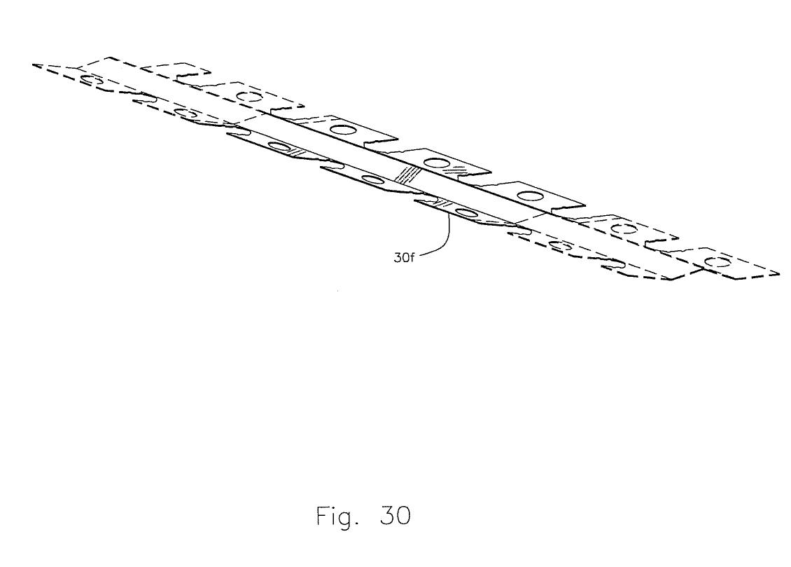

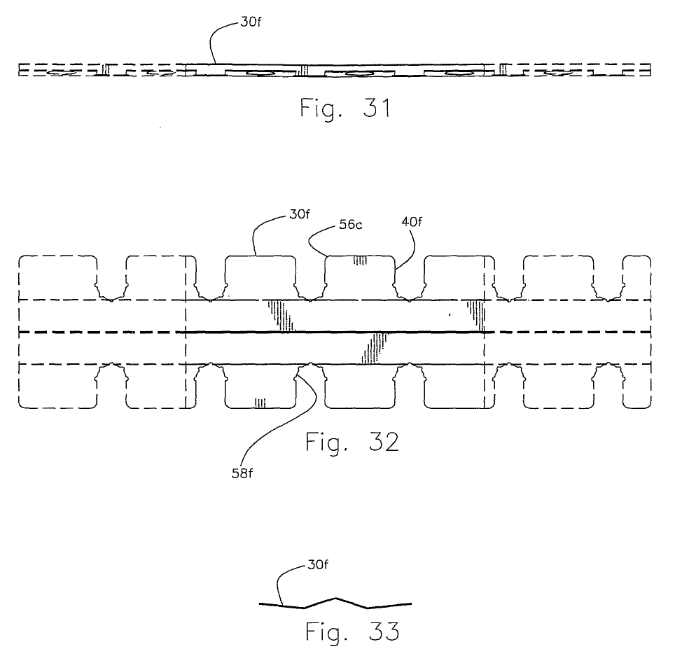

Referring now to FIGS. 30, 31, 32, 33, and 34, an alternative rigid mounting member 30F is provided, containing arcuate slot members 40F containing a rounded radius corner 56C (as in FIG. 7), and a multi-slot inner profile 58F.

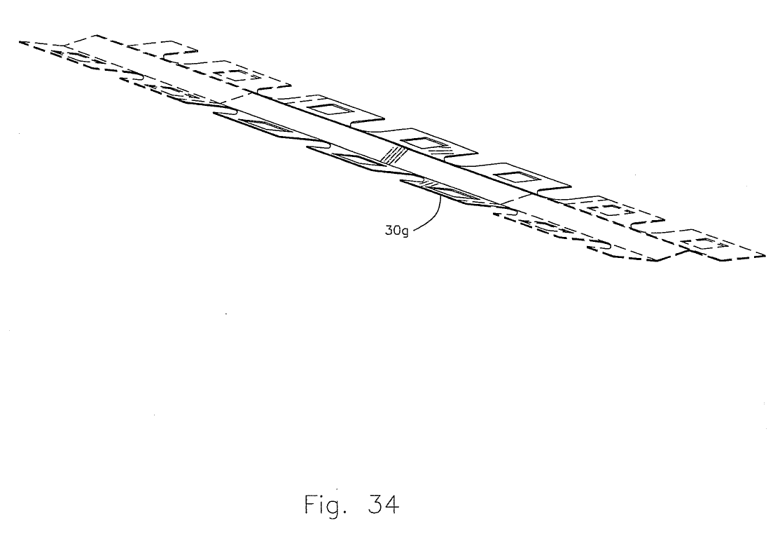

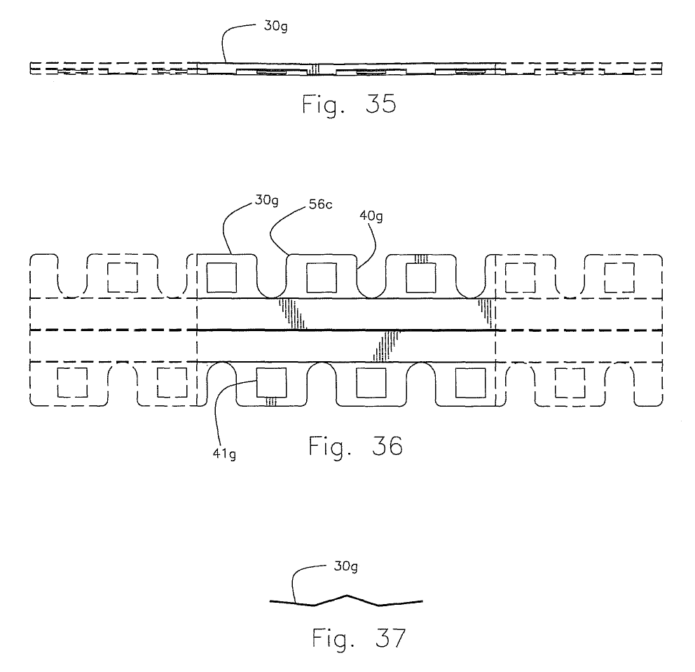

Referring now to FIGS. 34, 35, 36, and 37, an alternative rigid mounting member 30G is provided, containing arcuate slot members 40G containing a rounded radius corner 56C (as in FIG. 7), and square holes 41G, as shown.

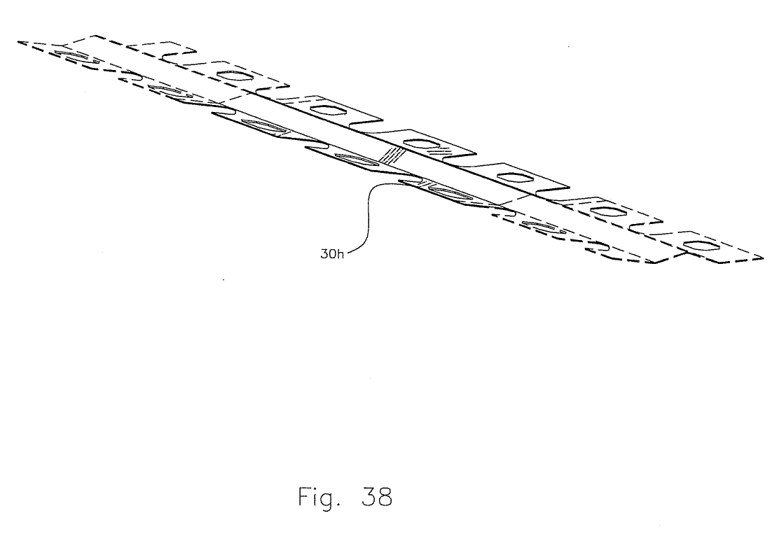

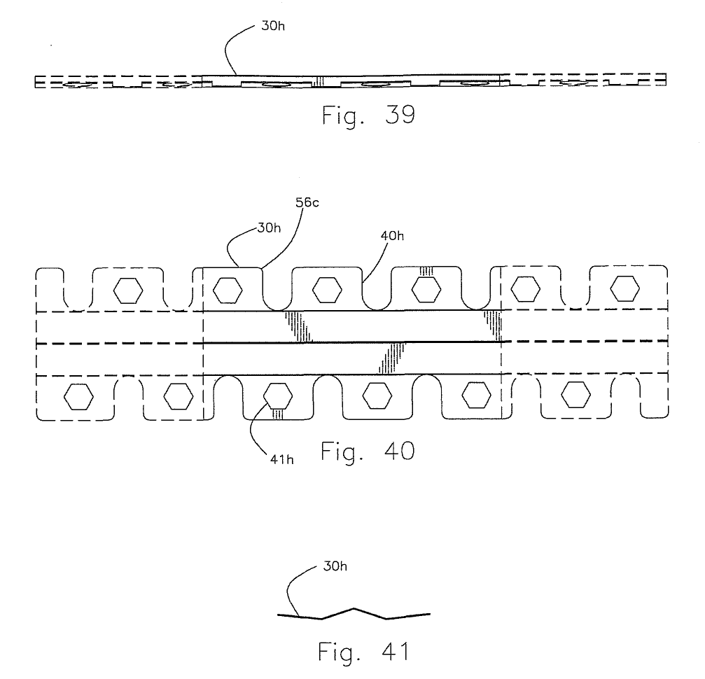

Referring now to FIGS. 38, 39, 40, and 41, an alternative rigid mounting member 30H is provided, containing arcuate slot members 40H containing a rounded radius corner 56C (as in FIG. 7) and hexagonal holes 41H.

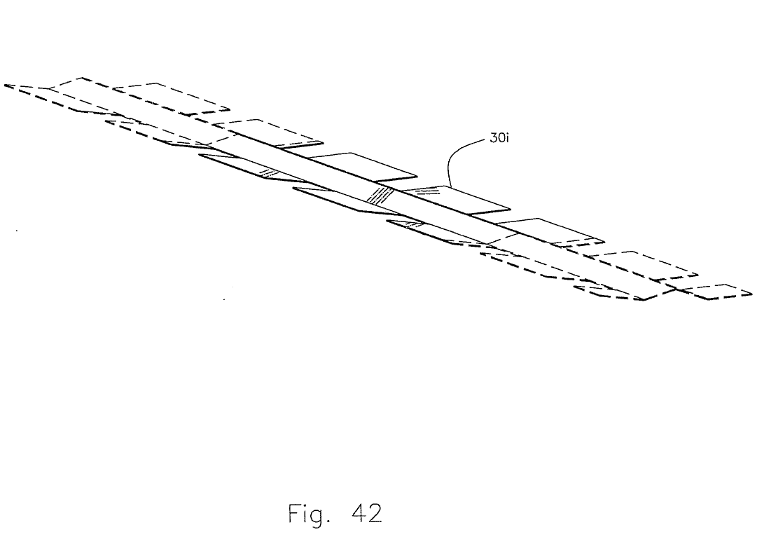

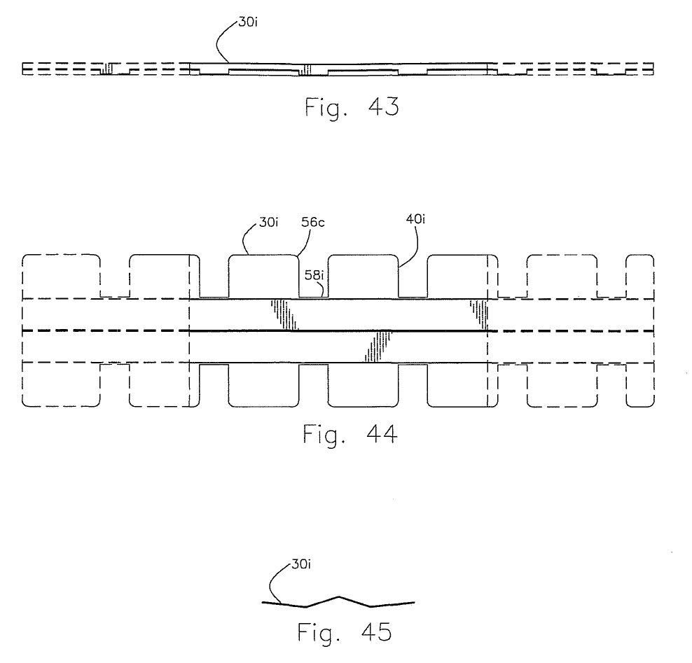

Referring now to FIGS. 42, 43, 44, and 45, an alternative rigid mounting member 30I is provided, containing arcuate slot members 40I containing a rounded radius corner 56C (as in FIG. 7) and a square bottom profile 58I.

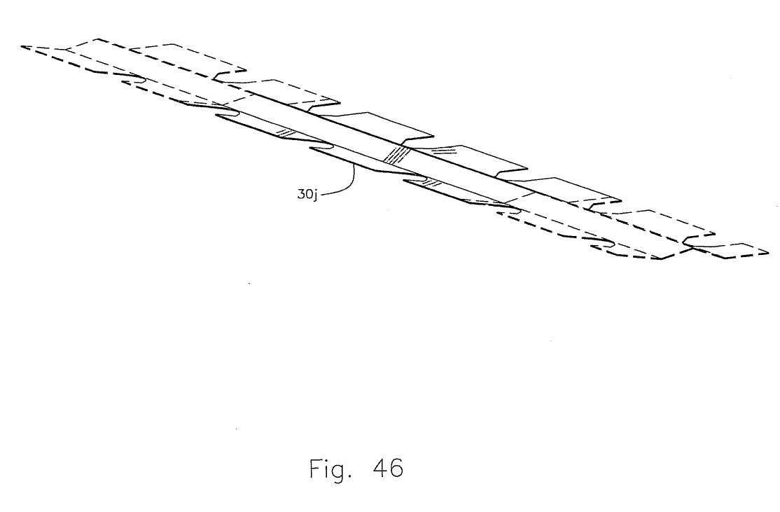

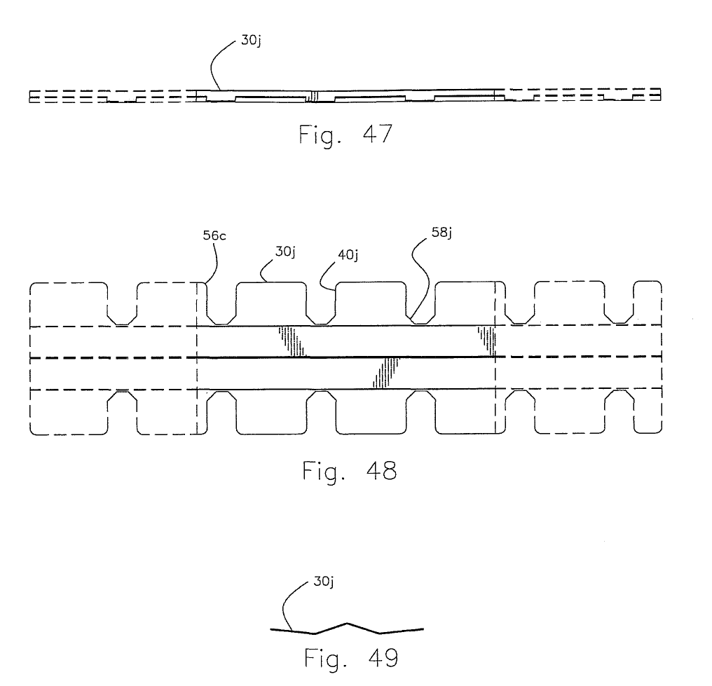

Referring now to FIGS. 46, 47, 48, and 49, an alternative rigid mounting member 30J is provided, containing arcuate slot members 40J containing a rounded radius corner 56C (as in FIG. 7) and angular profile 58J.

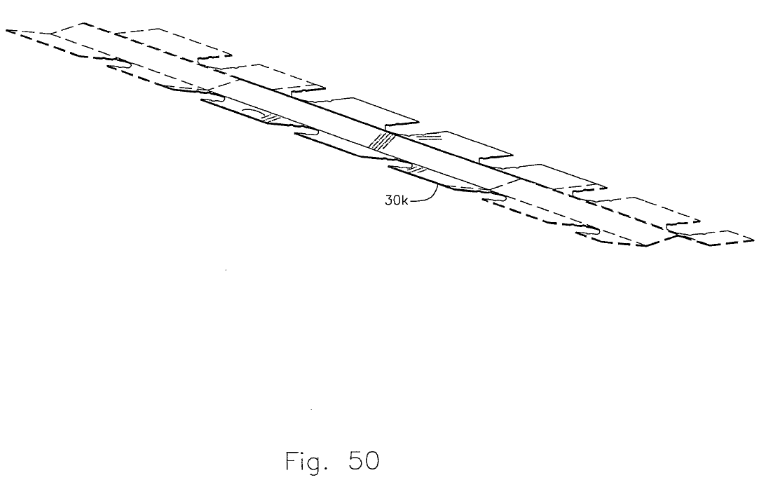

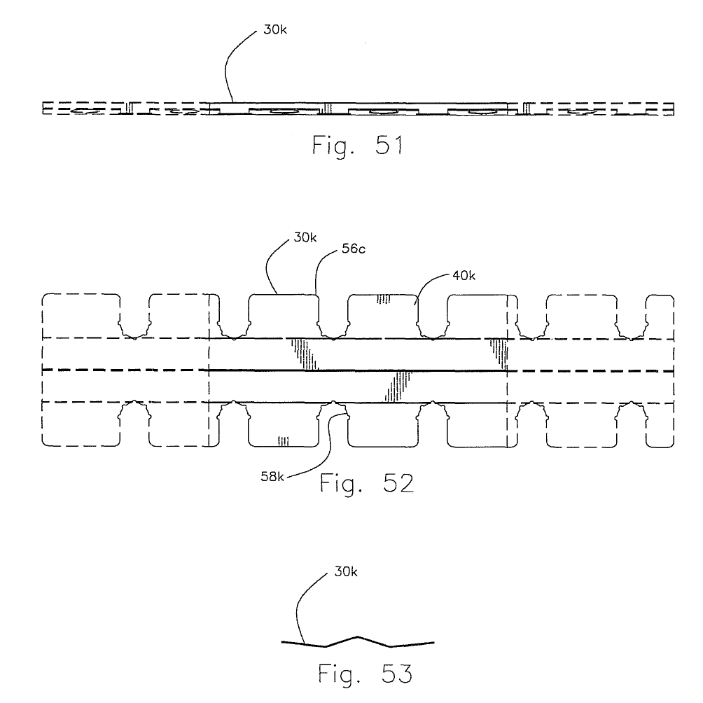

Referring now to FIGS. 50, 51, 52, and 53, an alternative rigid mounting member 30K is provided, containing arcuate slot members 40K containing a rounded radius corner 56C (as in FIG. 7) and multipoint bottom profiles 58K.

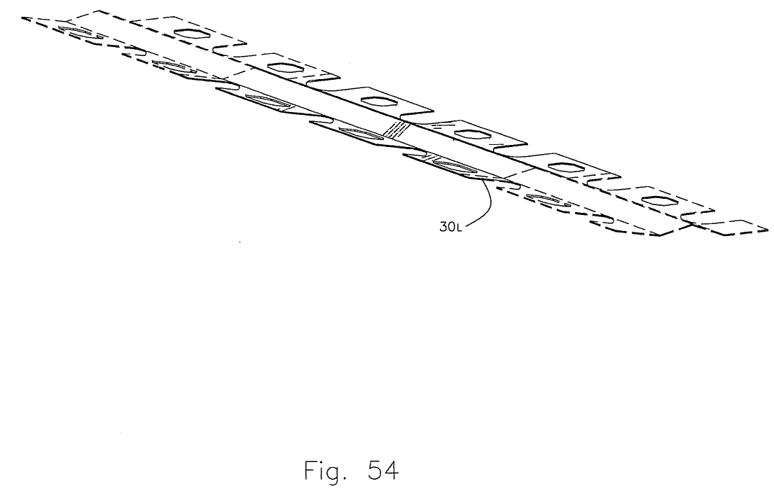

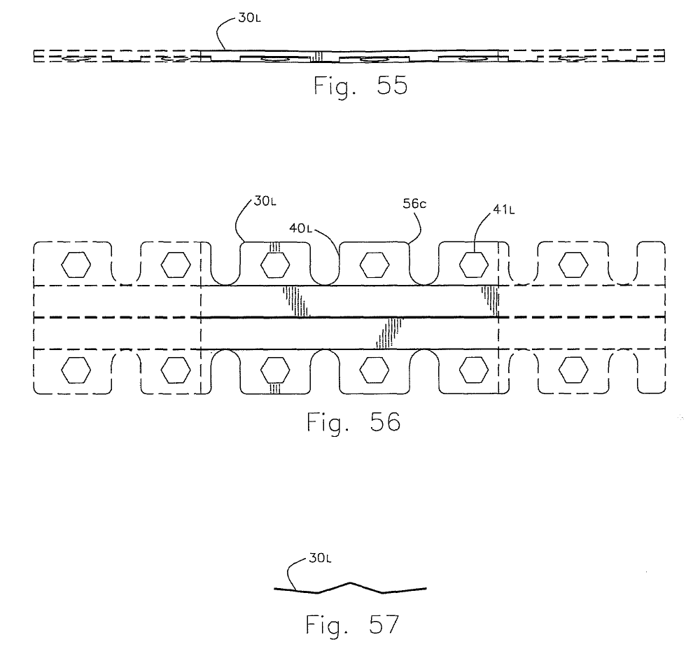

Referring now to FIGS. 54, 55, 56, and 57, an alternative rigid mounting member 30L is provided, containing arcuate slot members 40L containing a rounded radius corner 56C (as in FIG. 7) and hexagonal holes 41L.

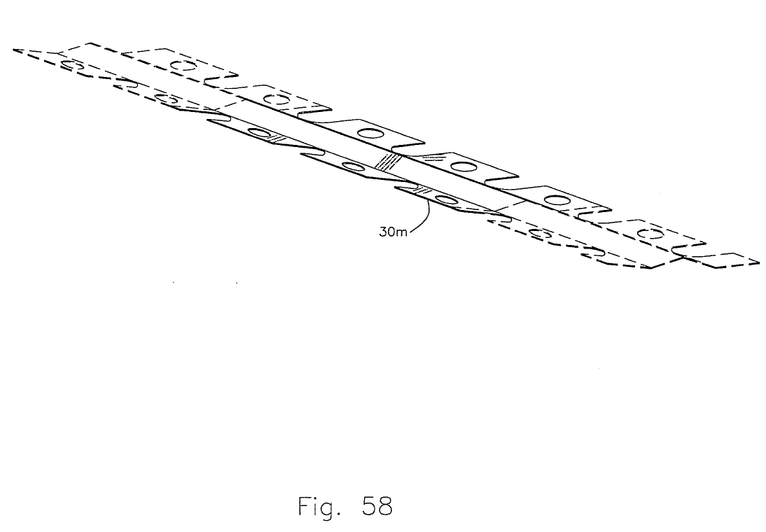

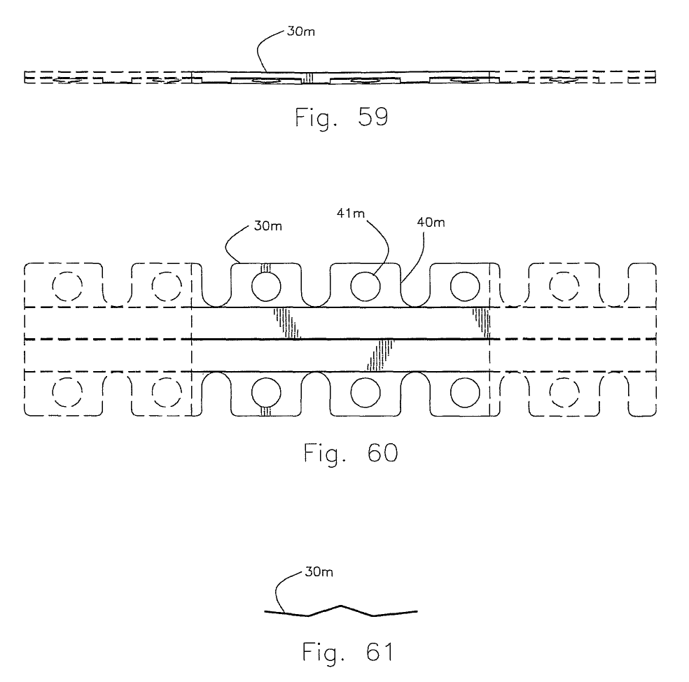

Referring now to FIGS. 58, 59, 60, and 61, an alternative rigid mounting member 30M is provided, containing arcuate slot members 40M containing a rounded radius corner 56C (as in FIG. 7) and round holes 41M.

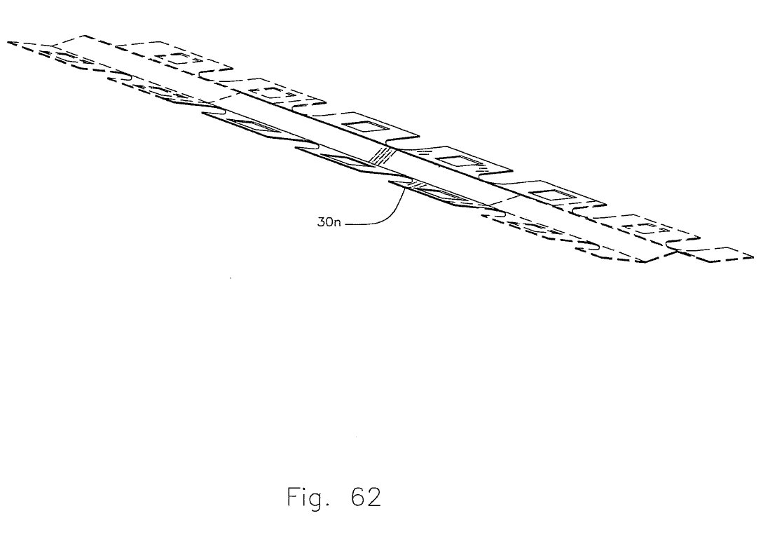

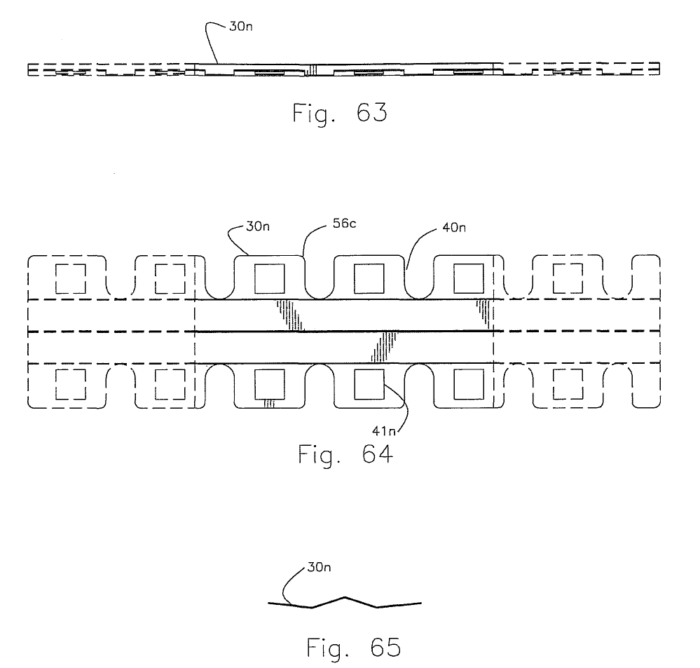

Referring now to FIGS. 62, 63, 64, and 65, an alternative rigid mounting member 30N is provided, containing arcuate slot members 40N containing a rounded radius corner 56C (as in FIG. 7) and square holes 41N.

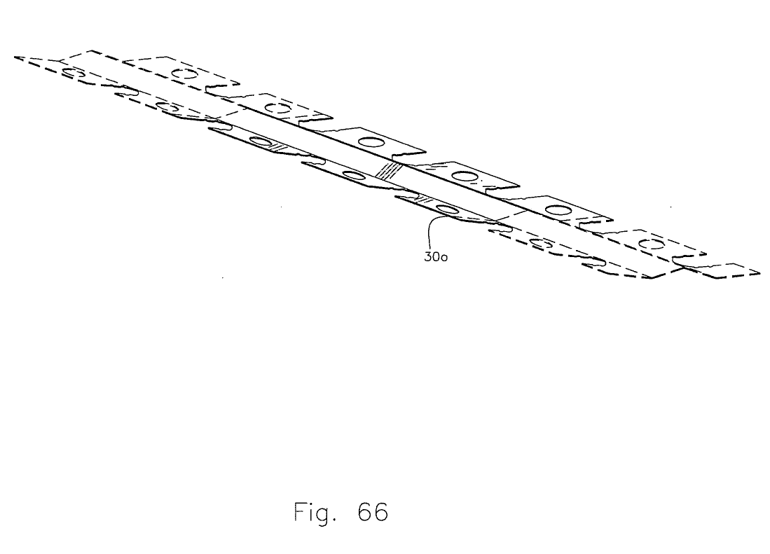

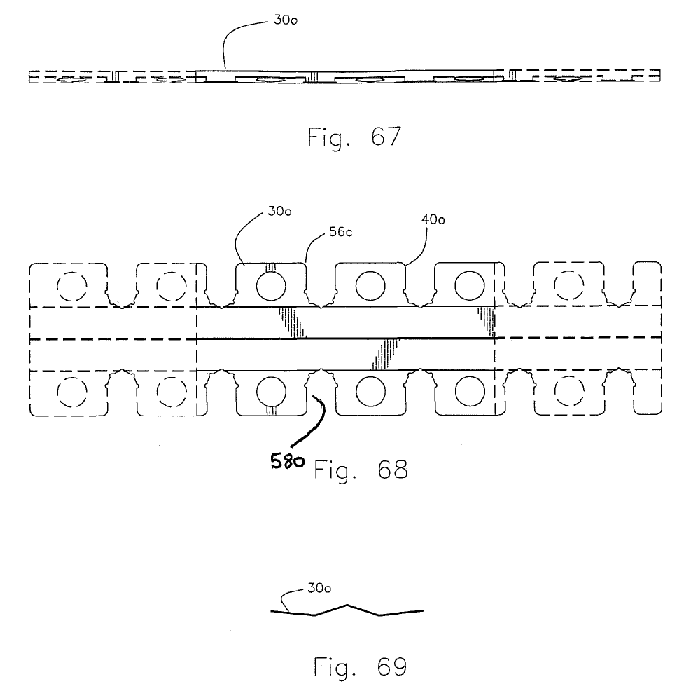

Referring now to FIGS. 66, 67, 68, and 69, an alternative rigid mounting member 30O is provided, containing arcuate slot members 40O containing a rounded radius corner 56C (as in FIG. 7) and round holes 41O, and inner profile 58O.

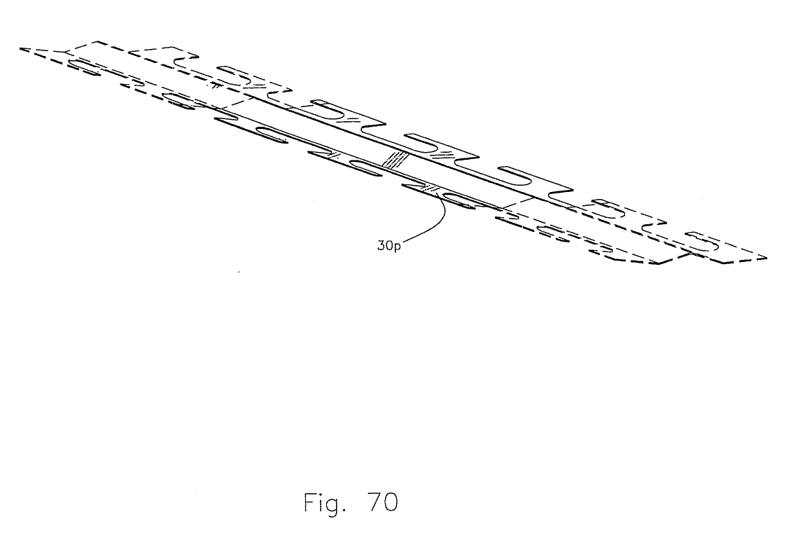

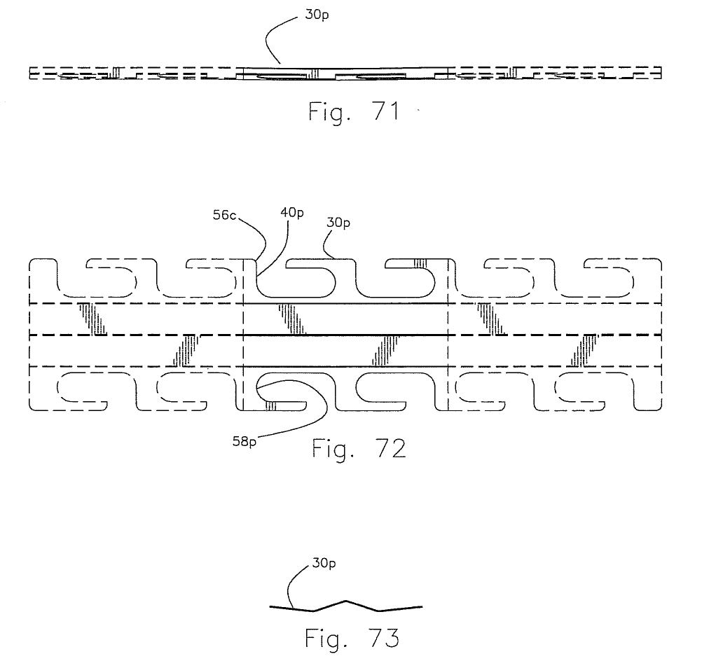

Referring now to FIGS. 70, 71, 72, and 73, an alternative rigid mounting member 30P is provided, containing elongated arcuate slot members 40P containing a rounded radius corner 56C (as in FIG. 7) and an inner hole profile with an outer wall 58P.

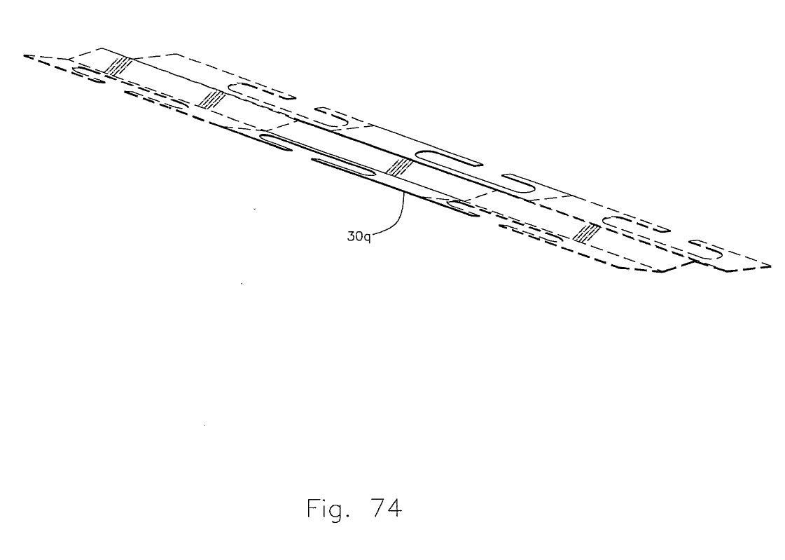

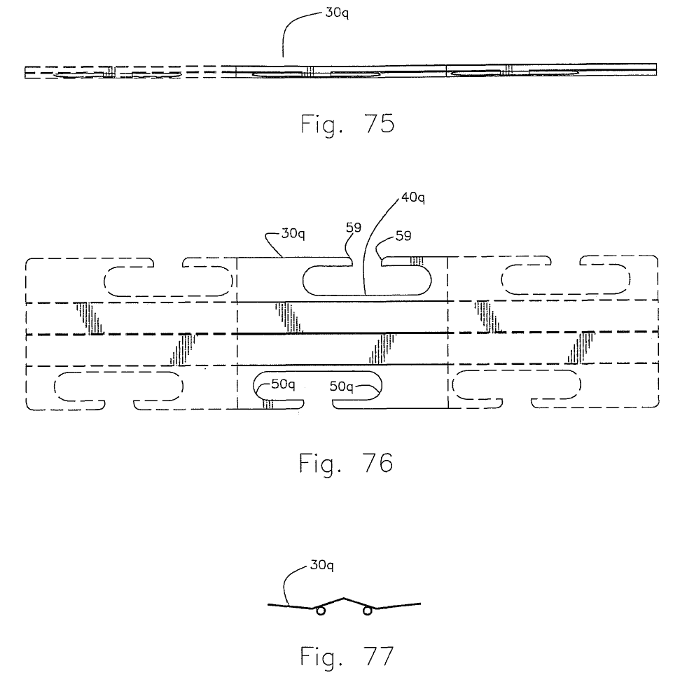

Referring now to FIGS. 74, 75, 76, and 77, an alternative rigid mounting member 30Q is provided, containing arcuate dual-extending slot members 40Q containing dual rounded radius corners 56Q (as in FIG. 7) and extending boundary arms 59.

It should be understood by those of skill in the art having studied the present disclosure that the individual leg members may be of alternative constructions, may be continuous or non-continuous, individual, etc., and may have differing lengths or be formed with adjustable length features all within the scope and spirit of the present invention. For example, the individual legs may be formed of straight wire members with length adjustment features to vary distance from a grilling surface to accommodate different length food items. Alternatively, a kit for the grilling system may contain separate different length leg members allowing a simple replacement to accommodate different length food items from the grilling surface. It is intended that each of these variants is within the scope and spirit of the present invention.

It should also be understood by those of skill in the art having studied the present disclosure that the use of labeling phrases such as grilling, cooking, microwaving, or other food-preparation labels are non-limiting and may be interchangeably used without departing from the scope and spirit of the present invention. For example, the system may be referred, without limitation and interchangeably as a grilling rack, cooking system, cooking rack, etc., all are within the scope and spirit of the present invention.

It should additionally be understood that the current system may be constructed from any suitable material now known or later developed. The envisioned materials are not limited to the proposed metal, but may also include microwave safe materials, ceramics, plastics, glasses, or other organic or inorganic materials suitable for the proposed purpose, all without departing from the scope and spirit of the present invention. Similarly, any proposed coating for ease of washing, cooking utility, or other need may be employed without departing from the scope and spirit of the present invention.

Those of skill in the art should understand following study of this application that the use of the phrase slot contours, slots, off-set slots, interspaced slots, alternating slots, intermittent slots, or related details are non-limiting and should be understood to be broad descriptors of ways to removably secure food items on the mounting member without departing from the scope and spirit of the present invention.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. 112, paragraph 6 to define the invention. To the contrary, if the provisions of 35 U.S.C. 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. 112, paragraph 6. Moreover, even if the provisions of 35 U.S.C. 112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the drawings and specification, there have been disclosed typical embodiments of the invention and, although specific terms are employed, they are used in a generic and descriptive sense only and not for purposes of limitation, the scope of the invention being set forth in the following claims.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A rack system, comprising:
a rigid mounting member comprising at least two elongate planar sections;
each said elongate planar section being jointed to at least one adjacent elongate planar section along an off-set angle region whereby each said elongate planar section is non-coplanar with respect to an adjacent said elongate planar section and whereby each said elongate planar section is nonparallel with an external support surface;
outer ones of said elongate planar sections containing a plurality of slot contours;
each said outer one of said elongate planar sections being non-coplanar with said opposing outer one of said elongate planar sections; and
each said slot contour extending from an external region of said respective elongate planar section inwardly toward proximate said off-set angle region, whereby each said off-set slot contour may removably retain an external item for support during a use.

2. A rack system, according to claim 1, further comprising:
at least one spring leg member;
each leg member being a continuous bent member, wherein opposing end regions project upwardly in use away from said external support surface along an upright reference plane;
projecting entry members on respective ends of each said end region;
each said entry member projecting opposite said entry member projecting from said opposing end region, whereby said entry members project away from each other on each said leg member;
at least one mounting member for each said projecting entry member on said rigid mounting member; and
each said mounting member being mounted on respective said alternating off-set angle regions.

3. A rack system, according to claim 2, wherein:
pairs of said mounting members proximate opposing ends of said rigid mounting member; and
one of each said pair of said mounting member being spaced from said at least one respective end of said rigid mounting member a distance different than a respective spaced distance for said other one of each said pair, whereby each one of each said pair of mounting member is a different distance from said respective end of said rigid mount member; and
whereby during an assembly of said continuous spring leg members with respective said mounting members an urging spring force is generated in use by urging respective end regions a direction away from said perpendicular reference plane to engage said mounting members thereby achieving an urging engagement while maintaining a first direction spring tension in each said leg member.

4. A rack system, according to claim 3, wherein:
opposing end regions of each respective spring leg member projecting upwardly in a co-parallel manner away from said external support surface; and said co-parallel manner is a first separation distance;
each respective said mounting members on respective said ends being mounted distant from said each other at a distance that is greater than said first separation distance of opposing end regions of each said spring leg member; and
whereby during said engagement said end regions are urged away from each other to achieve said engagement thereby maintaining a second direction spring tension in each said leg member.

5. A rack system, comprising:
a rigid mounting member comprising at least two elongate planar sections;
each said elongate planar section being jointed to at least one adjacent elongate planar section along an off-set angle region whereby each said elongate planar section is non-coplanar with respect to an adjacent said elongate planar section and whereby each said elongate planar section is nonparallel with an external support surface;
outer ones of said elongate planar sections containing a plurality of slot contours;
each said outer one of said elongate planar sections being non-coplanar with said opposing outer one of said elongate planar sections; each said slot contour extending from an external region of said respective elongate planar section toward proximate said off-set angle region, whereby each said slot contour may removably retain an external item for support during a use;
at least two spring leg members;
each leg member being a continuous bent member, wherein opposing end regions project upwardly in use away from said external support surface along an upright reference plane;
projecting entry members on respective ends of each said end region;
each said entry member projecting opposite said entry member projecting from said opposing end region, whereby said entry members project away from each other on each said leg member;
at least one mounting member for each said projecting entry member on said rigid mounting member; and
each said mounting member being mounted on respective said alternating off-set angle regions.

6. A rack system, according to claim 5, wherein:
pairs of said mounting members proximate opposing ends of said rigid mounting member; and
one of each said pair of said mounting member being spaced from said at least one respective end of said rigid mounting member a distance different than a respective spaced distance for said other one of each said pair, whereby each one of each said pair of mounting member is a different distance from said respective end of said rigid mount member; and
whereby during an assembly of said continuous spring leg members with respective said mounting members an urging spring force is generated in use by urging respective end regions a direction away from said perpendicular reference plane to engage said mounting members thereby achieving an urging engagement while maintaining a first direction spring tension in each said leg member.

7. A rack system, according to claim 6, wherein:
opposing end regions of each respective spring leg member projecting upwardly in a co-parallel manner away from said external support surface; and said co-parallel manner is a first separation distance;
each respective said mounting members on respective said ends being mounted distant from said each other at a distance that is greater than said first separation distance of opposing end regions of each said spring leg member; and
whereby during said engagement said end regions are urged away from each other to achieve said engagement thereby maintaining a second direction spring tension in each said leg member.

8. A rack system, comprising:
a rigid mounting member comprising at least two elongate planar sections;
each said elongate planar section being jointed to at least one adjacent elongate planar section along an off-set angle region whereby each said elongate planar section is non-coplanar with respect to an adjacent said elongate planar section and whereby each said elongate planar section is nonparallel with an external support surface;
outer ones of said elongate planar sections containing a plurality of off-set slot contours;
each said outer one of said elongate planar sections being non-coplanar with said opposing outer one of said elongate planar sections; each said off-set slot contour extending from an external region of said respective elongate planar section toward proximate said off-set angle region, whereby each said off-set slot contour may removably retain an external item for support;
at least two spring leg members;
each leg member being a continuous bent member, wherein opposing end regions project upwardly in use away from said external support surface along an upright reference plane;
projecting entry members on respective ends of each said end region;
each said entry member projecting opposite said entry member projecting from said opposing end region, whereby said entry members project away from each other on each said leg member;
at least one mounting member for each said projecting entry member on said rigid mounting member;
each said mounting member being mounted on respective said alternating off-set angle regions.
pairs of said mounting members proximate opposing ends of said rigid mounting member; and
one of each said pair of said mounting member being spaced from said at least one respective end of said rigid mounting member a distance different than a respective spaced distance for said other one of each said pair, whereby each one of each said pair of mounting member is a different distance from said respective end of said rigid mount member;
whereby during an assembly of said continuous spring leg members with respective said mounting members an urging spring force is generated in use by urging respective end regions a direction away from said perpendicular reference plane to engage said mounting members thereby achieving an urging engagement while maintaining a first direction spring tension in each said leg member.

9. A method of assembling a cooking system, comprising the steps of:
providing a rigid mounting member comprising a number of elongate planar sections; wherein:
each said elongate planar section being jointed to at least one adjacent elongate planar section along an alternating off-set angle region whereby each said elongate planar section is non-coplanar with respect to an adjacent said elongate planar section and whereby each said elongate planar section is nonparallel with an external support surface;
outer ones of said elongate planar sections containing a plurality of off-set slot contours;
each said outer one of said elongate planar sections being non-coplanar with said opposing outer one of said elongate planar sections; and
each said off-set slot contour extending from an external edge of said rigid mounting member to proximate said off-set angle region.

10. A method of assembling a cooking system, according to claim 9, further comprising the steps of:
providing a pair of continuous spring leg members;
each said leg member being a continuous bent member, wherein opposing end regions project upwardly away from said external support surface along a perpendicular reference plane;
projecting entry members on respective ends of each said end region;
each said entry member projecting opposite said entry member projecting from said opposing end region, whereby said entry members project away from each other;
providing at least one mounting member for each said projecting entry member; and
each said mounting member being mounted on respective said alternating off-set angle regions.

11. A method of assembling a cooking system, according to claim 9, further comprising the steps of:
providing pairs of said mounting members proximate opposing ends of said rigid mounting member;
one of each said pair of said mounting member being spaced from said respective end of said rigid mounting member a distance different than a respective spaced distance for said other one of each said pair, whereby each one of each said pair of mounting member is a different distance from said respective end of said rigid mount member; and
whereby during an assembly of said continuous spring leg members with respective said mounting members an urging spring force is created by urging respective end regions a direction away from said perpendicular reference plane to engage said mounting members thereby achieving an engagement while maintaining a first direction spring tension in each said leg member.

12. A method of assembling a cooking system, according to claim 11, further comprising the steps of:
controlling said opposing end regions of each respective spring leg member projecting upwardly in a co-parallel manner away from said external support surface; and said co-parallel manner is a first separation distance;
whereby each respective said mounting members on respective said ends being mounted distant from said each other at a distance that is greater than said first separation distance of opposing end regions of each said spring leg member; and
whereby during said engagement said end regions are urged away from each other to achieve said engagement thereby maintaining a second direction spring tension in each said leg member.
